(19) United States
(12) Patent Application Publication
(10) Pub. No.: US 2019/0294880 A1
(43) Pub. Date: Sep. 26, 2019

(54) AUXILIARY DISPLAY METHOD AND APPARATUS, AND DISPLAY SYSTEM

(71) Applicant: CLOUDMINDS (SHENZHEN) ROBOTICS SYSTEMS CO., LTD., Shenzhen (CN)

(72) Inventors: Kai WANG, Beijing (CN); Shiguo LIAN, Beijing (CN)

(73) Assignee: CLOUDMINDS (SHENZHEN) ROBOTICS SYSTEMS CO., LTD., Shenzhen (CN)

(21) Appl. No.: 16/439,785

(22) Filed: Jun. 13, 2019

Related U.S. Application Data
(63) Continuation of application No. PCT/CN2016/109929, filed on Dec. 14, 2016.

(51) Int. Cl. G06K 9/00; G06T 7/70; G08G 9/02

(52) U.S. Cl. CPC G06K 9/00671; G06K 9/00369; G06T 7/70; G06T 2207/30241; G06T 2207/30236; G06T 2207/30196; G08G 9/02

(57) ABSTRACT

The embodiment of the present invention discloses an auxiliary display method and apparatus, and a display system, and relates to the artificial intelligence and enhanced display technology. An image displayed on a back end client may be optimized, and necessary indication is provided for the service personnel to reduce the workload thereof. The method includes: obtaining data collected by a sensor of a front end device, the collected data comprise image data; analyzing the collected data to generate an indication identifier of a predetermined target in the image data; and synthesizing the indication identifier and the image data in the collected data into display data, and displaying the display data through a display device, wherein the indication identifier is associated with the predetermined target in the image data. The embodiment of the present invention is applied to auxiliary display.

### CROSS-REFERENCE TO RELATED APPLICATION

The present application is a continuation application under 35 U.S.C. § 120 of PCT application No. PCT/CN2016/109929 filed on Dec. 14, 2016, the contents of which are incorporated herein by reference.

### FIELD OF THE INVENTION

The embodiment of the present invention relates to the artificial intelligence and enhanced display technology, and in particular, to an auxiliary display method and apparatus, and a display system.

### BACKGROUND OF THE INVENTION

In recent years, with the rapid development of machine intelligence theory and computer hardware level, more and more machine intelligence technologies have been used to serve the works and lives of people in various fields. However, since the machine intelligence technology cannot be 100% reliable, the manual service in the background still needs to be combined in many applications. In the traditional manual service, the background service personnel need to rely on simple images displayed on display devices or the voice technology to monitor and operate front end users or robots. When scenarios presented by the images on back end clients are complex and the surrounding information amount is large, the workload of the service personnel will increase rapidly, and even information loss or wrong processing may occur due to the untimely processing.

### SUMMARY OF THE INVENTION

The embodiment of the present invention provides an auxiliary display method and apparatus, and a display system, which are capable of optimizing an image displayed on a display device and providing a necessary indication to service personnel to reduce the workload thereof.

In a first aspect, an auxiliary display method is provided, including:

obtaining data collected by a sensor of a front end device, the collected data include image data;

analyzing the collected data to generate an indication identifier of a predetermined target in the image data; and

synthesizing the indication identifier and the image data in the collected data into display data, and displaying the display data through a display device, wherein the indication identifier is associated with the predetermined target in the image data.

In a second aspect, an auxiliary display apparatus is provided, including:

an obtaining unit, configured to obtain data collected by a sensor of a front end device, the collected data include image data;

an analysis unit, configured to analyze the collected data obtained by the obtaining unit to generate an indication identifier of a predetermined target in the image data; and

an image synthesis unit, configured to synthesize the indication identifier obtained by the analysis unit and the image data in the collected data obtained by the obtaining unit into display data, and sending the display data to a client for display, wherein the indication identifier is associated with the predetermined target in the image data.

In a third aspect, an auxiliary display system is provided, including: a memory, a communication interface, a processor and a display device, wherein the memory, the communication interface and the display device are coupled to the processor; and the memory is configured to store a computer execution code, the processor is configured to execute the computer execution code to control the execution of the above auxiliary display method, and the communication interface is configured to perform data transmission between the auxiliary display apparatus and an external device.

In a fourth aspect, a computer storage medium is provided, for storing a computer software instruction used by the auxiliary display apparatus and containing a program code designed to execute the above auxiliary display method.

In a fifth aspect, a computer program product is provided, which is capable of being directly loaded in an internal memory of a computer and contains a software code, and the computer program may implement the above auxiliary display method after being loaded and executed by the computer.

In the above solution, the auxiliary display apparatus obtains data collected by the sensor of the front end device, the collected data include the image data; analyzes the collected data to generate the indication identifier of the predetermined target in the image data; and synthesizes the indication identifier and the image data in the collected data into display data, and displaying the display data through a display device, wherein the indication identifier is associated with the predetermined target in the image data, since the synthesized display data contain the indication identifier of the predetermined target, the service personnel using the display device may make corresponding judgment according to the indication identifier, when the scenario presented by the image is complicated and the amount of peripheral information is large, the workload of the service personnel may be reduced, and meanwhile, the situation of information loss or wrong processing caused by untimely processing is reduced or eliminated.

### BRIEF DESCRIPTION OF THE DRAWINGS

To illustrate technical solutions in the embodiments of the present invention more clearly, a brief introduction on the drawings which are needed in the description of the embodiments or the prior art is given below. Apparently, the drawings in the description below are merely some of the embodiments of the present invention, based on which other drawings may be obtained by those of ordinary skill in the art without any creative effort.

FIG. 1 is an architecture diagram of an auxiliary display system provided by an embodiment of the present invention;

FIG. 2 is an architecture diagram of an auxiliary display system provided by another embodiment of the present invention;

FIG. 3 is a flow diagram of an auxiliary display method provided by an embodiment of the present invention;

FIG. 4 is a schematic diagram of an image generated by an auxiliary display method provided by an embodiment of the present invention;

FIG. 5 is a schematic diagram of another image generated by an auxiliary display method provided by an embodiment of the present invention;

FIG. 6 is a schematic diagram of yet another image generated by an auxiliary display method provided by an embodiment of the present invention;

FIG. 7 is a structure diagram of an auxiliary display apparatus provided by an embodiment of the present invention;

FIG. 8A is a structure diagram of an auxiliary display apparatus provided by another embodiment of the present invention; and

FIG. 8B is a structure diagram of an auxiliary display apparatus provided by yet another embodiment of the present invention.

### DETAILED DESCRIPTION OF THE EMBODIMENTS

A system architecture and a service scenario described in the embodiment of the present invention are for the purpose of more clearly illustrating the technical solutions of the embodiment of the present invention, and do not constitute a limitation of the technical solutions provided by the embodiment of the present invention. Those of ordinary skill in the art may know that the technical solutions provided by the embodiment of the present invention are also applicable to similar technical problems with the evolution of the system architecture and the appearance of new service scenes.

It should be noted that, in the embodiment of the present invention, the words “exemplary” or “for example” or the like are used for meaning examples, example illustration or illustration. Any embodiment or design solution described as “exemplary” or “for example” in the embodiment of the present invention should not be construed as be more preferred or advantageous than other embodiments or design solutions. Properly speaking, the words “exemplary” or “for example” or the like are intended to present related concepts in a specific manner.

It should be noted that, in the embodiment of the present invention, “of (English: of)”, “corresponding (English: corresponding, relevant)” and “corresponding (English: corresponding)” may sometimes be mixed for use. It should be noted that, when the difference is not emphasized, the meanings to be expressed are the same.

A client provided by the embodiment of the present invention may be a personal computer (English full name: personal computer, abbreviation: PC), a netbook, a personal digital assistant (English full name: Personal Digital Assistant, referred to as PDA) or the like, or, the above client may be a PC and the like, which is installed with a software client or a software system or a software application that is capable of executing the method provided by the embodiment of the present invention, a specific hardware implementation environment may be a general computer form, or an ASIC way, or an FPGA, or some programmable expansion platforms such as Xtensa platform of Tensilica and the like. A server provided by the embodiment of the present invention includes a local domain name server, a local proxy server and a network server. The embodiment of the present invention provides the server for providing a computing service in response to a service request. The basic components include a processor, a hard disk, a memory, a system bus and the like, which is similar to the general computer architecture.

The basic principle of the present invention is as follows: an auxiliary display apparatus generates an indication identifier for a predetermined target in collected data, synthesizes the indication identifier and image data into display data by means of rendering or other means, and displays the display data by the display device, in this way, the service personnel may make corresponding judgment according to the indication identifier, when the scenario presented by an image is complicated and the amount of peripheral information is large, the workload of the service personnel may be reduced, and meanwhile, the situation of information loss or wrong processing caused by untimely processing is reduced or eliminated.

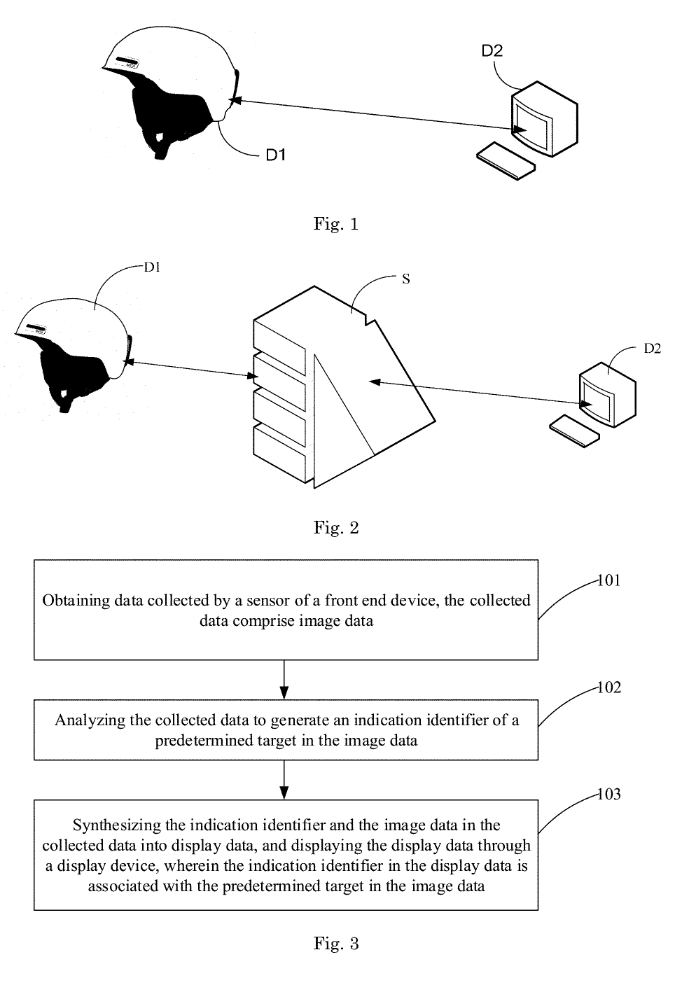

Referring to FIG. 1, an auxiliary display system provided by the embodiment of the present invention includes an auxiliary display apparatus provided by the embodiment of the present invention, wherein the implementation form includes the following two architectures. The first structure includes: a front end device D1 and a client D2 connected with the front end device, wherein the client D2 is the auxiliary display apparatus provided by the embodiment of the present invention; when the data collected by the auxiliary display apparatus are relatively simple, the data collected by the front end device may be directly processed under the computing resources of the client D2 in the auxiliary display method provided by the embodiment of the present invention, and synthesized display data are directly displayed on a display device of the client D2.

Of course, the client D2 may also only perform data collection and does not have data processing functions, so that only few computing resources may be configured to the client D2 to reduce the cost, in this way, the embodiment of the present invention provides another system architecture, as shown in FIG. 2, the second architecture includes a front end device D1, a server S and a client D2, the front end device D1 and the client D2 are connected with the server S, such that the server S is the auxiliary display apparatus provided by the embodiment of the present invention; therefore, even if the amount of data collected by the front end device D1 is large, the server S may also provide sufficient computing resources to implement the auxiliary display method provided by the embodiment of the present invention, so that the front end device D1 collects the data and sends the data to the server S, and the server S synthesizes the display data and sends the same to the display device of the client D2 for display. The front end device may be a portable terminal device, such as a wearable helmet, a headset; and a mobile device such as a mobile phone, a tablet computer or the like. That is, the embodiment of the present invention may be executed by the server in cooperation with the client, or may be separately executed by the client.

Based on the above system, as shown in FIG. 3, the embodiment of the present invention provides an auxiliary display method, including the following steps:

101. Obtaining data collected by a sensor of a front end device, the collected data include image data.

In the step 101, the sensor may be an image sensor, a sound sensor and an ultrasonic radar sensor, wherein the collected data may be image data collected by the image sensor, audio data collected by the sound sensor and ultrasonic data collected by the ultrasonic radar sensor. Wherein the image sensor may be an infrared sensor, a CMOS sensor or the like. During the specific implementation, the above method may be applied to blind guide, the front end device here may be a blind guide front end device at this time, such as the blind guide helmet shown in FIG. 2. The above-mentioned sensor is mounted on the blind guide helmet.

102. Analyzing the collected data to generate an indication identifier of a predetermined target in the image data.

The predetermined target here may be a travel route of a user carrying the front end device, an obstacle around the user and a person or a traffic facility around the user, and may also include other target objects, which is not specifically limited herein.

103. Synthesizing the indication identifier and the image data in the collected data into display data to be displayed by the display device, wherein the indication identifier in the display data is associated with the predetermined target in the image data.

Wherein, in the step 103, the display data may be displayed in the display device in a first view angle manner of the user carrying the front end device, and of course may also be displayed in an observation view angle. When the display data are displayed in the observation view angle, the method further includes in the step 103: synthesizing a location of the user carrying the front end device in the display data.

Specifically, when the predetermined target includes the travel route of the user carrying the front end device, the indication identifier includes an identifier disposed on the travel route for indicating the forward direction of the user. Specifically, if the display data are displayed in the display device in the observation view angle, then the location of the user in a map may be displayed in the displayed image data, for example, displayed in the form of a 2D picture. The travel route from the location of the user to the destination may be presented in 3D lines, and of course, may also be displayed in other ways, such as 2D lines of special colors, the indication identifier herein has the function of indicating the forward direction of the user, and thus may be presented in the form of an arrow, for example, may be a 3D arrow or a arrow of a special color, and its direction may indicate the travel direction of the user.

In addition, the predetermined target may also be an obstacle, a person or a traffic facility around the user carrying the front end device; and the indication identifier is used for displaying related data of the predetermined target. Specifically, the related data of the obstacle at least include one or more of the following: type, color, outline, orientation, number, and distance from the user of the obstacle; the related data of the person at least include one or more of the following: location, outline, identity ID, gender and age of the person; the related data of the traffic facility at least include one or more of the following: location of the traffic facility, and contents indicated by the traffic facility.

Exemplarily, for the obstacle, the outline of the obstacle may be framed by a rectangular frame or a circular frame around the location of obstacle to identify the outline of the obstacle, and the type, color, outline, orientation, number, the distance from the user and other information of the obstacle are displayed around (for example, in the rectangular frame or the circular frame) of the obstacle by using numeral. For the person, the outline may be framed by a rectangular frame or a circular frame around the location of person to identify the outline of the person, and the identity ID, gender and age of the person are displayed around (for example, in the rectangular frame or the circular frame) of the person by using numeral. For the traffic facility, the contents indicated by the traffic facility may be directly displayed on the location of the traffic facility, for example, the state red/green/yellow light of a current traffic light is displayed at the location of the traffic light, and a no-pass mark is displayed at a no-pass scutcheon, etc. The above description is only for the purpose of illustrating some exemplary descriptions provided by the embodiment of the present invention, and other similar or easily convertible solutions should also fall within the protection scope of the present application.

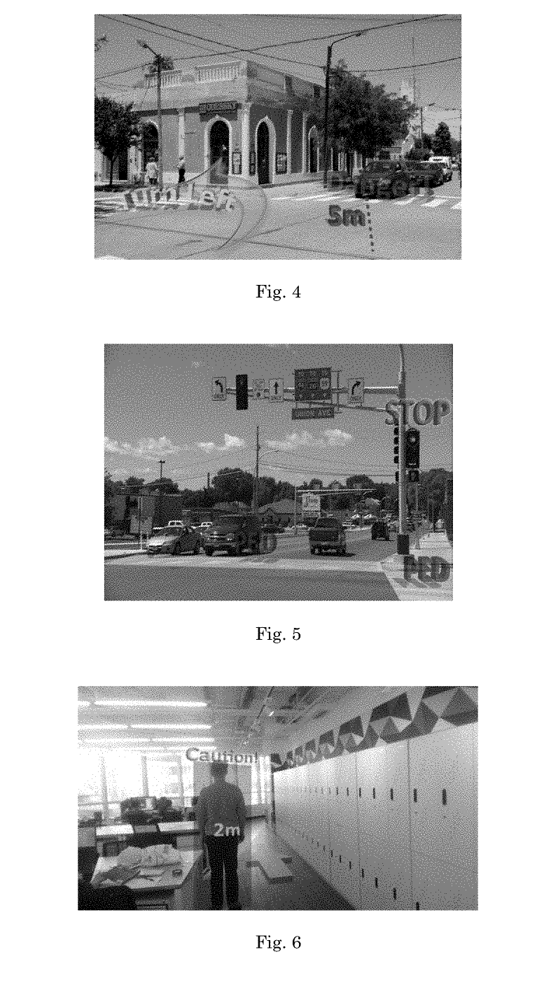

Referring specifically to FIG. 4, the forward direction of user on the travel line is displayed by the arrows and characters Turn Left. Taking a vehicle as the obstacle, the location of the vehicle in the image is displayed by Danger!, and the distance between the vehicle and the user is displayed by 5m. In FIG. 5, the location of a zebra crossing of the traffic facility in the image is shown by PED, and the state of the traffic light of the traffic facility in the image is shown by STOP. It is prompted that a person is around the user in the image in FIG. 6 by Caution!, an outline range of the person is provided and is identified by a rectangular frame, the height of the person is marked as 2m, and meanwhile, the forward direction of the user is provided by the arrow. In the above solution, the auxiliary display apparatus obtains data collected by the sensor of the front end device, the collected data include the image data; analyzes the collected data to generate the indication identifier of the predetermined target in the image data; and synthesizes the indication identifier and the image data in the collected data into display data, and sends the display data to the display device for display, wherein the indication identifier is associated with the predetermined target in the image data, since the synthesized display data contain the indication identifier of the predetermined target, the service personnel using the display device may make corresponding judgment according to the indication identifier, when the scenario presented by the image is complicated and the amount of peripheral information is large, the workload of the service personnel may be reduced, and meanwhile, the situation of information loss or wrong processing caused by untimely processing is reduced or eliminated.

It may be understood that the auxiliary display apparatus implements the functions provided by the above embodiment through hardware structures and/or software modules contained therein. Those skilled in the art will readily appreciate that the present invention may be implemented by hardware or a combination of hardware and computer software in combination with the units and algorithm steps of the various examples described in the embodiments disclosed herein. Whether a certain function is implemented in the form of hardware or driving the hardware via the computer software is determined by specific applications and design constraint conditions of the technical solutions. Those skilled in the art may implement the described functions by using different methods for each specific application, but this implementation should not be considered beyond the scope of the present invention.

The embodiment of the present invention may divide the function modules of the auxiliary display apparatus according to the above method example, for example, the function modules may be divided according to the functions, and two or more functions may also be integrated into one processing module. The above integrated module may be implemented in the form of hardware and may also be implemented in the form of a software function module. It should be noted that the division of the modules in the embodiment of the present invention is schematic and is only a logical function division, and other division manners may be provided during the actual implementation.

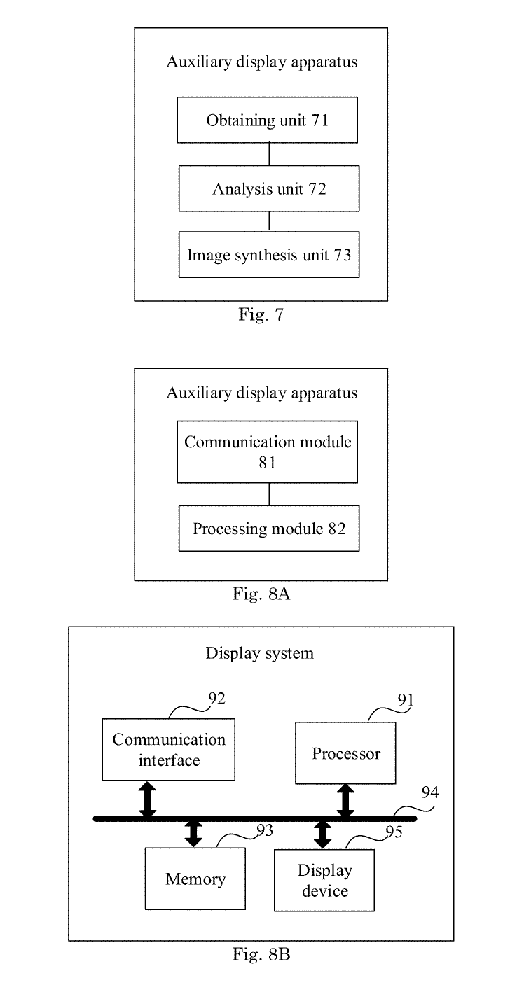

In the case that the function modules are divided according to the functions, FIG. 7 shows a possible structural schematic diagram of the auxiliary display apparatus involved in the above embodiment, the auxiliary display apparatus includes: an obtaining unit 71, an analysis unit 72 and an image synthesis unit 73. The obtaining unit 71 is configured to support the auxiliary display apparatus to execute the process 101 in FIG. 3; the analysis unit 72 is configured to support the auxiliary display apparatus to execute the process 102 in FIG. 3; and the image synthesis unit 73 is configured to support the auxiliary display apparatus to execute the process 103 in FIG. 3. All the related contents of the steps involved in the foregoing method embodiment may be quoted to the function descriptions of the corresponding function modules, and thus details are not described herein again.

In the case that the integrated unit is adopted, FIG. 8A shows a possible structural schematic diagram of the auxiliary display apparatus involved in the above embodiment. The auxiliary display apparatus includes a communication module 81 and a processing module 82. The processing module 82 is configured to perform control management on the actions of the auxiliary display apparatus, for example, the processing module 82 is configured to support the auxiliary display apparatus to execute the processes 102 and 103 in FIG. 3. The communication module 81 is configured to support the data transmission between the auxiliary display apparatus and other external devices, for example, the communication with the front end device as shown in FIG. 2. The auxiliary display apparatus may also include a storage module 83, configured to store a program code and data of the auxiliary display apparatus.

The processing module 82 may be a processor or a controller, for example, may be a central processing unit (central processing unit, CPU), a general purpose processor, a digital signal processor (digital signal processor, DSP), an application-specific integrated circuit (application-specific integrated circuit, ASIC), a field programmable gate array (field programmable gate array, FPGA) or other programmable logic devices, transistor logic devices, hardware components or any combinations thereof. The processing module may implement or execute logic boxes, modules and circuits of various examples described in combination with the contents disclosed by the present invention. The processor may also be a combination for implementing a computing function, for example, a combination including one or more microprocessors, a combination of a DSP and a microprocessor, and the like. The communication module 81 may be a transceiver, a transceiver circuit, a communication interface or the like. The storage module may be a memory.

Exemplarily, the processing module 82 may be a processor, the communication module 81 may be communication interface, and the storage module may be a memory, as shown in FIG. 8B, a display system is provided, including: a processor 91, a communication interface 92, a memory 93, a bus 94 and a display device 95; the memory 93, the communication interface 92 and the display device 95 are coupled to the processor 91 by the bus 94, wherein the communication interface 92, the processor 91 and the memory 93 are connected to each other by the bus 94; and bus 94 may be a peripheral component interconnect (Peripheral Component Interconnect, PCI) bus or an extended industry standard architecture (Extended Industry Standard Architecture, EISA) bus or the like. The bus may be divided into an address bus, a data bus, a control bus and the like. For the ease of representation, the bus is only expressed by a thick line in FIG. 8B, but it does not mean that there is only one bus or one type of bus. The display system may only include only a client and may also be composed of a client and a server, wherein the client and the server are similar, and both include respective processors, communication interfaces and memories.

The embodiment of the present invention further provides a robot, including the above auxiliary display apparatus.

The steps of the method or algorithm described in combination with the contents disclosed by the present invention may be implemented in the form of hardware and may also be implemented by a processor executing software instructions. The software instructions may be composed of corresponding software modules, and the software modules may be stored in a random access memory (Random Access Memory, RAM), a flash memory, a read only memory (Read Only Memory, ROM), an erasable programmable read-only memory (Erasable Programmable ROM, EPROM), an electrically erasable programmable read-only memory (Electrically EPROM, EEPROM), a register, a hard disk, a mobile hard disk, a CD-ROM (CD-ROM) or any other form of storage medium known in the art. An exemplary storage medium is coupled to the processor, so that the processor may read information from and write information to the storage medium. Of course, the storage medium may also be a constituent part of the processor. The processor and the storage medium may be located in an ASIC. Additionally, the ASIC may be located in a core network interface device. Of course, the processor and the storage medium may also exist as discrete components in the core network interface device.

Those skilled in the art should be aware that, in one or more examples described above, the functions described in the present invention may be implemented by hardware, software, firmware, or any combination thereof. When implemented by the software, these functions may be stored in a computer readable medium or transmitted as one or more instructions or codes on the computer readable medium. The computer readable medium includes a computer storage medium and a communication medium, wherein the communication medium includes any medium that may conveniently transfer the computer program from one place to another. The storage medium may be any available medium that may be accessed by a general purpose or special purpose computer.

The objectives, technical solutions and beneficial effects of the present invention have been further described in detail by the above specific embodiments, it should be understood that the foregoing descriptions are merely the specific embodiments of the present invention, rather than limiting the protection scope of the present invention, and any modifications, equivalent replacements, improvements and the like, made on the basis of the technical solutions of the present invention, should be included in the protection scope of the present invention.

1. An auxiliary display method, comprising:
obtaining data collected by a sensor of a front end device, the collected data comprise image data;
analyzing the collected data to generate an indication identifier of a predetermined target in the image data; and
synthesizing the indication identifier and the image data in the collected data into display data, and displaying the display data through a display device, wherein the indication identifier in the display data is associated with the predetermined target in the image data.

2. The method according to claim 1, wherein the predetermined target comprises a travel route of the user carrying the front end device; and
the indication identifier comprises an identifier disposed on the travel route for indicating the forward direction of the user.

3. The method according to claim 1, wherein the predetermined target comprises at least one of more of the following items: an obstacle, a person and a traffic facility around the user carrying the front end device; and
the indication identifier is used for displaying related data of the predetermined target.

4. The method according to claim 3, wherein the related data of the obstacle at least comprise one or more of the following items: type, color, outline, orientation, number, and distance from the user of the obstacle;
the related data of the person at least comprise one or more of the following items: location, outline, identity ID, gender and age of the person;
the related data of the traffic facility at least comprise one or more of the following items: location of the traffic facility, and contents indicated by the traffic facility.

5. The method according to claim 1, wherein the method further comprises:
synthesizing a location of the user carrying the front end device in the display data.

6. The method according to claim 1, wherein the collected data further comprise one or more of the following items: audio data and ultrasonic data.

7. The method according to claim 1, wherein the front end device is a blind guide front end device.

8. A display system, comprising: a memory, a communication interface, a processor and a display device; the memory, the communication interface and the display device are coupled to the processor; and the memory is configured to store a computer execution code, the processor is configured to execute the computer execution code to control the execution of the auxiliary display method according to claim 1, and the communication interface is configured to perform data transmission between an auxiliary display apparatus and an external device.

9. A computer storage medium, for storing a computer software instruction used by an auxiliary display apparatus and comprising a program code designed to execute the auxiliary display method according to claim 1.
